(19) United States
(12) Patent Application Publication
(10) Pub. No.: US 2011/0296306 A1
(43) Pub. Date: Dec. 1, 2011

(54) METHODS AND SYSTEMS FOR PERSONAL SUPPORT ASSISTANCE

(75) Inventors: Lars Oddsson, Edina, MN (US); Daniel Nilsson, Minneapolis, MN (US); Mary Radomski, New Brighton, MN (US); Matthew White, Eden Prairie, MN (US)

(73) Assignee: Allina Hospitals & Clinics, Minneapolis, MN (US)

(21) Appl. No.: 12/875,250

(22) Filed: Sep. 3, 2010

Related U.S. Application Data
(60) Provisional application No. 61/275,934, filed on Sep. 4, 2009.

(51) Int. Cl. G06F 3/048; G06F 15/16

(52) U.S. Cl. 715/717

(57) ABSTRACT

The various embodiments disclosed herein relate to network-based personal support systems and related methods. The systems and methods relate to providing support to a user through various types of interactions between the user and a personal support unit. The systems and methods can also relate to collecting and analyzing data relating to the interactions and further can include adjusting or modifying future interactions with the user based on the analysis of the data.

### CROSS-REFERENCE TO RELATED APPLICATION(S)

This application claims priority to Provisional Application No. 61/275,934, filed Sep. 4, 2009, which is hereby incorporated herein by reference in its entirety.

### FIELD OF THE INVENTION

This disclosure relates generally to the field of computing systems and networks and in various embodiments to methods, devices, and systems for robotic and/or automated personal assistance or support, including treatment adherence assistance for patients.

### BACKGROUND OF THE INVENTION

Personal assistance and personal training are in high demand. Many people seek the guidance of specialists for various facets of their life, including fitness, diet, and overall health. In addition, patients with chronic ailments often need assistance in adhering to medical and rehabilitative recommendations. An individual who self-administers a prescribed medication may mistakenly take more or less than the recommended dose. For example, the individual may take too many pills or too few pills, and may take the medicines at incorrect times. Others may fail to initiate a recommended treatment, miss an appointment with the consulting physician, or discontinue the treatment before complete healing of the disease. Still others may not properly follow suggested therapeutic exercises and/or diet recommendations.

In addition, there may be a need for real-time analysis of the treatment or program followed by the individual. Based on the analysis of the treatment or program, the individual may need or desire some changes in therapy, diet, exercises, etc. The consultant may not be updated about the individual's state after initiation of therapy, exercises, etc. Low adherence to medical and rehabilitative recommendations may result in an increased number of medical emergencies and/or other complications.

There is a need in the art for improved systems and methods for assisting a person with adherence to a fitness or diet regime, medical or rehabilitative treatments, or other similar health-related actions or plans.

### BRIEF SUMMARY OF THE INVENTION

In Example 1, a network-based personal support system for at least one user comprises a central processor accessible on a computer network, a database in communication with the central processor, a controller interface in communication with the central processor, at least one personal interaction unit in communication with the central processor and disposed at a user location, location software, entertainment software, and reminder software. The database is configured to store user information. The personal interaction unit has a unit processor, a user interface, and at least one speaker. The location software is configured to transmit instructions to the unit to perform an initial search for a specified user. The entertainment software is configured to transmit instructions to the unit to actuate an entertainment module, wherein the entertainment module comprises music, a video broadcast, or an interactive game. The reminder software is configured to transmit at least one reminder to the user via the user interface regarding an impending deadline or event.

Example 2 relates to the system according to Example 1, wherein the personal interaction unit is a robotic unit comprising a motor, a set of wheels operably coupled to the motor, and at least one sensor associated with the unit, the at least one sensor configured to sense landmarks or path marks for navigation.

Example 3 relates to the system according to Example 1, wherein the personal interaction unit is a stationary unit disposed at a central location in a building at the user location.

Example 4 relates to the system according to Example 1, further comprising a plurality of personal interaction units in communication with the central processor and disposed at a plurality of user locations.

Example 5 relates to the system according to Example 1, wherein the at least one personal interaction unit further comprises a camera and a microphone.

Example 6 relates to the system according to Example 1, wherein the user location comprises a plurality of users, wherein the at least one personal interaction unit is configured to interact with each of the plurality of users.

Example 7 relates to the system according to Example 1, further comprising exercise software associated with the system, the exercise software configured to transmit instructions to the user via the user interface regarding an exercise routine.

Example 8 relates to the system according to Example 7, further comprising at least one exercise device operably coupled to the personal interaction unit, wherein the exercise software is further configured to transmit instructions to the user regarding the exercise routine using the at least one exercise device.

Example 9 relates to the system according to Example 7, wherein the exercise software is further configured to collect data relating to the exercise routine and analyze the data.

Example 10 relates to the system according to Example 1, wherein if the initial search is unsuccessful, the location software is further configured to transmit additional instructions to the unit to either perform a more intensive search or to transmit at least one sound to get the specified user's attention.

Example 11 relates to the system according to Example 10, wherein, if the more intensive search or the at least one sound is unsuccessful, the location software is further configured to transmit a communication to a designated person or location.

In Example 12, a network-based personal support system for at least one user comprises a central processor accessible on a computer network, a database in communication with the central processor, a controller interface in communication with the central processor, at least one personal interaction unit in communication with the central processor and disposed at a user location, exercise software, reminder software, and feedback software, The database is configured to store user information. The personal interaction unit comprises a user interface and at least one speaker. The exercise software is configured to transmit instructions to the user via the user interface regarding an exercise routine. The reminder software is configured to transmit at least one reminder to the user via the user interface regarding an impending deadline or event. The feedback software is configured to process user interaction information and transmit feedback information to the user via the personal interaction unit.

Example 13 relates to the system according to Example 12, wherein the personal interaction unit is a stationary unit integrally incorporated into at least one room of a building at the user location.

Example 14 relates to the system according to Example 12, further comprising a plurality of personal interaction units in communication with the central processor and disposed at a plurality of user locations.

Example 15 relates to the system according to Example 12, wherein the user location comprises at least one user, wherein the at least one personal interaction unit is configured to interact with the at least one user.

Example 16 relates to the system according to Example 12, further comprising at least one exercise device operably coupled to the personal interaction unit, wherein the exercise software is further configured to transmit instructions to the user regarding the exercise routine using the at least one exercise device.

Example 17 relates to the system according to Example 12, wherein the exercise software is further configured to collect data relating to the exercise routine and analyze the data.

In Example 18, a network-based personal support system for a plurality of users comprises a central processor accessible on a computer network, a database in communication with the central processor, a controller interface in communication with the central processor, a plurality of personal interaction units, each of the plurality of units being in communication with the central processor and disposed at a multi-user location, exercise software, reminder software, and feedback software. The database is configured to store user information relating to a plurality of users. The personal interaction unit has a user interface and at least one speaker. The exercise software is configured to transmit instructions to the user via the user interface regarding an exercise routine. The reminder software is configured to transmit at least one reminder to the user via the user interface regarding an impending deadline or event. The feedback software is configured to process user interaction information and transmit feedback information to the user via the personal interaction unit

Example 19 relates to the system according to Example 18, wherein the multi-user location is a hospital, clinic, treatment center, nursing home, or school.

Example 20 relates to the system according to Example 18, wherein a first personal interaction unit of the plurality of personal interaction units is configured to communicate with a second of the plurality of personal interaction units via the computer network, whereby a first user of the plurality of users can communicate with a second of the plurality of users.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram of a personal support system configuration, according to one embodiment.

FIG. 2 is a schematic depiction of a personal interaction unit in a user environment, according to one embodiment.

FIG. 3 is a schematic depiction of a path of a personal interaction unit, according to one embodiment.

FIG. 4 is a graphical representation of dynamic mapping and localization of a personal interaction unit, according to one embodiment.

FIG. 5 is a perspective view of an exercise device, according to one embodiment.

FIG. 6 is a perspective view of another exercise device, according to a further embodiment.

FIG. 7 is a flow chart illustrating a method of a personal interaction unit locating and/or establishing communication with a user, in accordance with one embodiment.

FIG. 8 is a flow chart depicting various types of interaction between a user and a personal interaction unit, according to one embodiment.

FIG. 9 is a flow chart illustrating the tracking, storing, and processing of information by a personal support system, in accordance with one embodiment.

FIG. 10 is a flow chart depicting a method of processing and analyzing the emotions of a user, according to one embodiment.

FIG. 11 is a flow chart illustrating a method of a user creating, developing, or otherwise providing a user interaction to a personal support system, according to one embodiment.

### DETAILED DESCRIPTION

Various embodiments disclosed herein relate to methods, devices, and systems for robotic and/or automated personal assistance, companionship, or support. In some implementations, the robotic and/or automated personal assistance or support relates to treatment adherence assistance for patients. Although various embodiments have been described herein with reference to specific exemplary embodiments, it will be evident that various modifications and changes may be made to these embodiments without departing from the broader spirit and scope of the various embodiments.

Various embodiments discussed in further detail below relate to an automated and/or robotic personal unit or system that can provide personal assistance to a user. For example, the unit or system can assist the user with dietary guidance, fitness training, therapeutic or medicinal treatment guidance, entertainment, social interaction, social networking, or other personal assistance by interacting with the user. In some implementations, the unit or system can provide both short term assistance (such as, for example, reminding the user to take her pill at the appropriate time) and long term assistance (such as tracking the number of pills that the user has over time and reminding her when it is time to obtain more pills). In other embodiments, the unit or system can also “build up a relationship” with the user over time. That is, the unit or system can track the relevant actions or behaviors of the user over time, recognize a pattern based on those actions or behaviors, and provide instructions or suggested action or behavior modifications to the user based on that pattern.

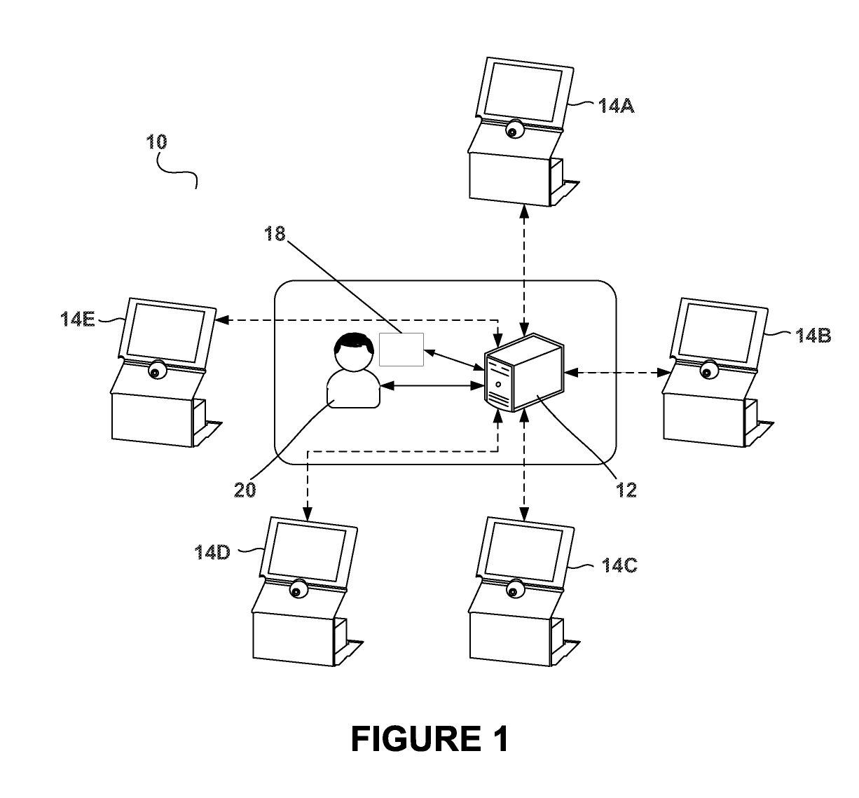

Certain implementations relate to a personal assistance system. FIG. 1 is a schematic depiction of a system embodiment 10 that is a network 10 having a server (also referred to herein as a “central processor”) 12 and multiple personal assistance units 14A-14E communicatively coupled to the central processor 12. In this embodiment, the various units 14A-14E can be distributed across multiple different locations anywhere in the world. It is understood that the system 10 can have any number of units, ranging from one unit to the maximum number of units that the central processor 12 can support. For purposes of this document, unit 14 shall refer to a single representational unit according to any embodiment contemplated herein, while any or all of units 14A-14E shall refer to multiple units, each unit having any configuration according to any embodiment contemplated herein. In various alternative embodiments, the system 10 can be a local or personal system 10 in which both the server 12 and the unit 14 (or the two or more units 14A-14E) are located in the same location, building, or home. In such smaller or more localized systems, the server 12 may be a personal computer or other known processor.

In one implementation, the server 12 is a standard, commercially available network server 12. Alternatively, the server 12 is made up at least two or more servers 12 or central processors 12 that operate together, such as, for example, in a cloud computing configuration. It is understood that the processor 12 can be any known processor or server that can be used with any network-based system of any size.

According to one embodiment, the network 10 is a local area network (“LAN”). Alternatively, the network 10 is a wide area network (“WAN”). In a further alternative, the network 10 is the Internet. In yet another alternative, the network 10 is any known type of network.

Continuing with FIG. 1, the central processor 12 can be positioned at any location. In certain embodiments, the central processor 12 is located at a central location. Alternatively, the server 12 can be located at an assistance center, such as a treatment center, clinic, healthcare center, doctor's office, hospital, fitness facility, diet facility, nursing home, or any other appropriate location, while the units 14A-14E are located at the homes or residences of the users. Alternatively, in those embodiments in which the system 10 is a personal or local system 10, the server 12 and the unit 14 or units 14A-14E are in the same building or general location, with the units 14A-14E distributed in various rooms or buildings at the location. For example, in one embodiment in which the system 10 is being operated at a nursing home, the server 12 could be located in a room dedicated to administrative or information technology purposes or any other central or appropriate location, while the units 14A-14E could be distributed in various rooms on the premises, such as various resident rooms and/or various treatment or activity rooms.

According to some embodiments, the connection between the server 12 and the unit 14 or units 14A-E can be a wired connection or a wireless connection. The server 12 can have a database or be coupled to a database that provides for storage of user information. In one implementation, the server 12 is configured to continually or regularly collect further or updated user information about each user and process that information as described in further detail below. As shown in FIG. 1, the server 12 can also be connected to an interface 18 (such as, for example, a personal computer, a personal digital assistant, a handheld device, or any other similar device). According to one embodiment, a human controller 20 can access the user information, run reports relating to the data, perform analyses relating to the data, communicate with any of the units 14A-14E, communicate with any user through the appropriate unit 14 or perform various other such actions as described in further detail herein via the interface 18. According to one embodiment, the human controller 20 is a physician, surgeon, trainer, therapist, or any other person who can provide appropriate assistance to a user via the system 10.

In certain implementations, the human controller 20 can access the user information of a specific user at the interface 18, review and analyze the information, and, based on the analysis, enter instructions relating to the analysis at the interface 18 that will be transmitted or otherwise transferred to the unit 14 that will trigger the unit 14 to provide certain information or instructions to the user or take certain actions with respect to the user or environment. As an example, the human controller 20 can provide support or assistant to one or more users by using the interface 18 to “log on” to or otherwise communicate with the unit 14. The communication with the unit 14 can include accessing information stored on the unit 14 or accessing real-time information being collected by the unit 14 such as audio, video, or other information relating to the user or the user environment. Further, the communication can also include the human controller 20 transmitting information to the unit 14 to be transmitted to the user, such as audio communication, visual communication, textual communication (such as a text message), or information in any other form. As a more specific example, the human controller 20 in certain embodiments can be a physical therapist 20 who logs on to the unit 14 via the interface 18 and accesses information to examine and analyze a patient's physical therapy progress and then transmit further instructions to the user that are provided to the user by the unit 14 relating to a new or revised physical training regimen. In one or more embodiments, the system 10 allows the human controller 20 and the user to communicate in real-time via the interface 18 and the unit 14.

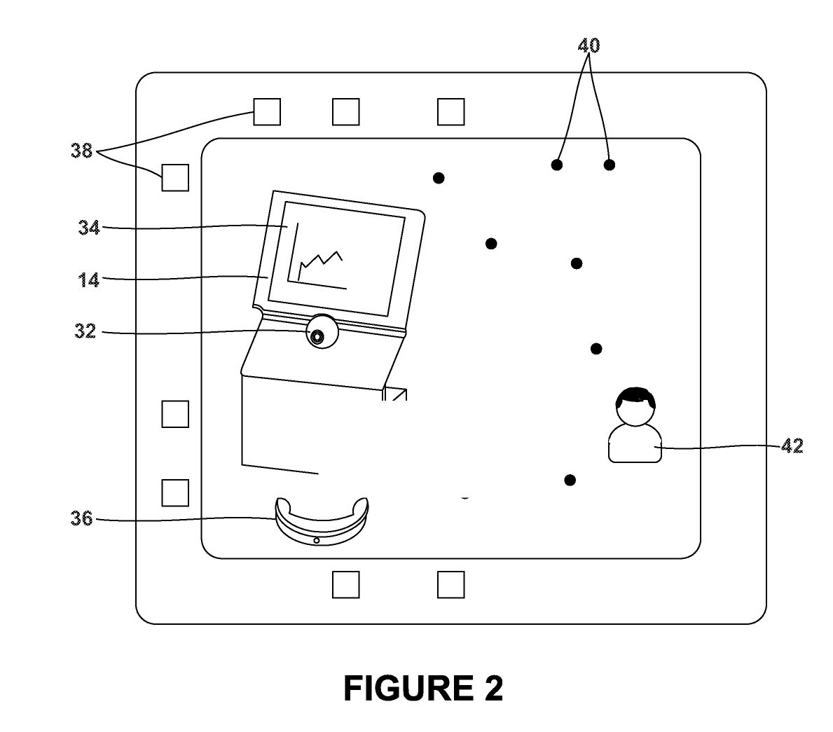

FIG. 2 is a schematic depiction of a personal assistance unit 14—more specifically a robotic personal assistance unit 14—in a user's environment, according to one embodiment. For purposes of this discussion, it is understood that the personal assistance unit 14 can be the same as the unit 14 or units 14A-14E depicted in FIG. 1 and discussed above, and will be referred to herein by the same reference number for purposes of clarity and continuity. However, it is further understood that the personal assistance unit 14 in FIG. 2 can be different from the units 14A-14E in any number of ways, including any embodiment differentiations described elsewhere herein. In one implementation, the user's environment is the user's home. Alternatively, the user's environment is a group setting such as a group therapy session, a hospital, a group retirement home, a school, or the like. It is understood that the robotic unit 14 can be part of a large, widely dispersed system such as that shown in FIG. 1, or alternatively can be part of a system having only the robotic unit 14 shown in FIG. 2 or only a small number of units.

In a further embodiment, it is understood that any device that can connect to the network 10 can be a unit 14 or serve as a unit 14 for some period of time. In other words, any computer or device that is coupled to the network 10—such as, in some exemplary embodiments, the Internet 14—either via a wired connection or a wireless connection, can provide much of the functionality described herein. In one example, any known wireless handheld device such as a personal digital assistant (“PDA”) or smartphone can be used to access the system 10. In such embodiments, the user can use the computer or device to log in to the system 10 or otherwise identify herself or himself to the system 10 and thereby access the user's information on the system 10 and interact with the system 10 according to any of the various functions and interactions described herein. In this way, the various embodiments described or contemplated herein can be fully location independent—that is, the user can access and use the system 10 from anywhere in the world.

The robotic personal assistance unit 14 as shown in FIG. 2 can perform various functions and interact with the user in a number of ways in the user's environment, as will be described in further detail below. In one or more embodiments, the unit 14 can be located in a system environment (e.g., a user's home or a group setting) to provide assistance or support, such as treatment adherence support, to a user 42 (e.g., a patient) or more than one user. The unit 14, in one implementation, has a processor (not shown) such as a microprocessor or any other known processing unit that could be incorporated into a computer or robotic device. The unit 14 can also have a camera 32 to capture the landmarks, user's activities, images, etc. in the user's home. According to one embodiment, the unit 14 is configured to identify the user or users through voice, image, and/or any other recognition system (e.g., finger print, facial recognition, etc.).

In further implementations, the personal assistance unit 14 can be configured to record the user's actions in a variety of formats. For example, any unit 14 contemplated herein can record not only data entered or provided by the user, but also can record sound (including, for example, the user's voice) and/or video sequences relating to the user and/or the user's environment. This recorded information can be transmitted, communicated, or otherwise transferred to the server 12 by the unit 14. In addition, in certain embodiments, the human controller 20 can subsequently access this recorded information via the interface 18. As described above, the controller 20 can review and analyze this recorded information and transmit new or revised instructions to the unit 14 and thus the user based on the analyzed information.

According to one embodiment, the personal assistance unit 14 has an interface (not shown) that allows the user to input information into and gather information from the unit 14. The interface can be used by the user to enter information relating to the user's actions, including any interaction with the unit or any exercises or other activities as described elsewhere herein. In a further implementation, the interface on the unit 14 can be used by the user to communicate with another user at another unit 14 via the network 10. That is, in any embodiment in which there is more than one unit 14 coupled to the network 10, the system 10 can allow for any two or more users to communicate with each other via the interfaces on their respective units 14.

In one or more embodiments, the robotic unit 14 may automatically dock with a charging station, such as, for example, docking station 36 as shown in FIG. 2, through computer vision or other known sensing technologies. The robotic unit 14 can recharge itself by returning to the charging station 36 before the batteries are discharged completely. In one implementation, the robotic unit 14 may be functional even while charging, to provide support, such as treatment adherence assistance or any other kind of assistance, to the user or users. In another embodiment, the unit 14 can be configured to be shut down or placed into a “sleep” mode while it is docked with the charging station 36 or at any other time. In this “shut down” state or “sleep” mode, the unit 14 does not interact with the user/users or the user environment.

According to various implementations, the robotic unit 14 is configured to move around the user environment. This can be accomplished using any one of several methods. For example, in one embodiment, the camera 32 can perform a known technique commonly referred to as simultaneous localization and mapping (SLAM) of the environment in which the unit 14 may move around. The unit 14 can move around by following the path marks (e.g., path mark 40) and may use land marks (e.g., a land mark 38) to navigate in the environment. The land mark 38 is any object that is typically found in the user environment, such as, for example, a picture on the wall of a room, a structure, and/or any geographical feature that is recognizable by the robotic unit 14. The path mark 40, in contrast, is any object that is placed in the user environment specifically to mark a path or location for the unit 14, and includes any such mark in the environment (e.g., room, home, etc.) along which the unit 14 may navigate. Examples of path marks 40 include reflective markers, sonic beacons, magnetic markers, bar code markers, or any other known marker that can be detected by the unit 14 and serve as a path mark 40. In one embodiment, when the robotic unit 14 comes across the first land mark 38, the unit 14 can update its position on a map using SLAM. The map can be displayed on a display device 34 as illustrated in FIG. 2.

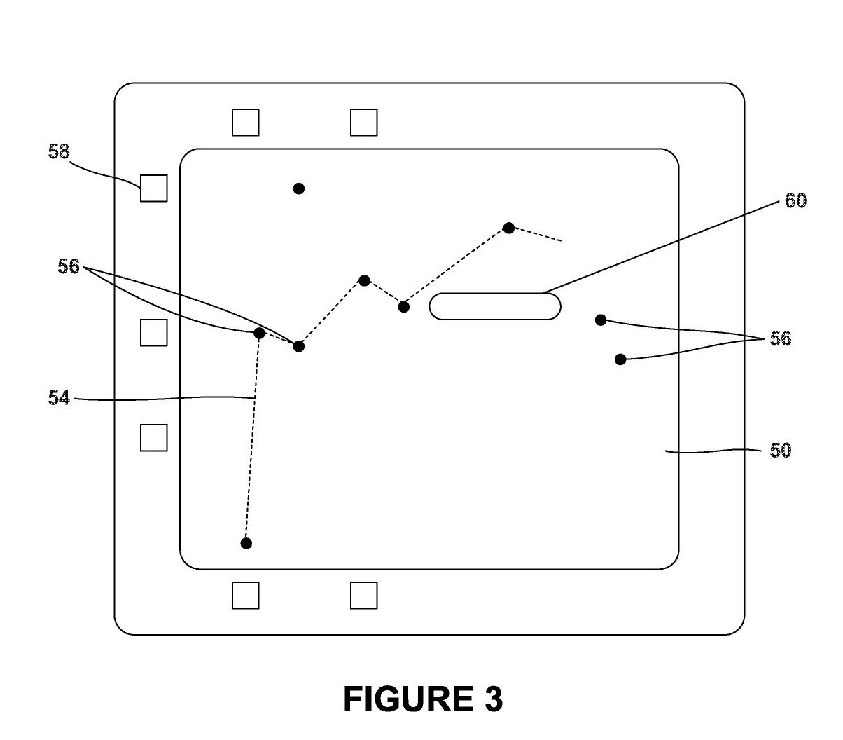

FIG. 3 is a graphical depiction further illustrating the movement (as depicted by the path 54) of the robotic personal assistance unit 14 in a user environment 50, according to one embodiment. As discussed above, the unit 14 can be the same as or similar to any of the units depicted in FIG. 1 or 2 and discussed above. Alternatively, the unit 14 can have a different configuration and/or different components and functionalities. As shown, in one or more implementations, the unit 14 may update its position while navigating in the user environment 50. The representational path 54 illustrates the path that the unit 14 has traversed in the environment 50. In one embodiment, the resulting graph can be displayed on a display device (not shown) on the unit 14, as described above with respect to FIG. 2. In one or more embodiments, the real-time motion of the unit 14 can be represented on such a map using a known graphical representation known as a virtual field histogram.

As further shown in FIG. 3, the robotic unit 14 may traverse along a path 54 that is configured or created using the path marks 56 placed in the user environment 50. Additionally, one or more land marks 58 (e.g., a picture, portrait, etc.) can also be used to navigate in the environment 50. If an obstacle 60 (e.g., carpet, threshold, edges, furniture, structure, etc.) is located in the path of the unit 14 (such as path 54, for example), the unit 14 can detect any such obstacle 60 via the unit's sensors (e.g., ultrasonic sensors, etc.) (not shown) and perform an avoidance action or routine according to known processes to avoid the obstacle 60.

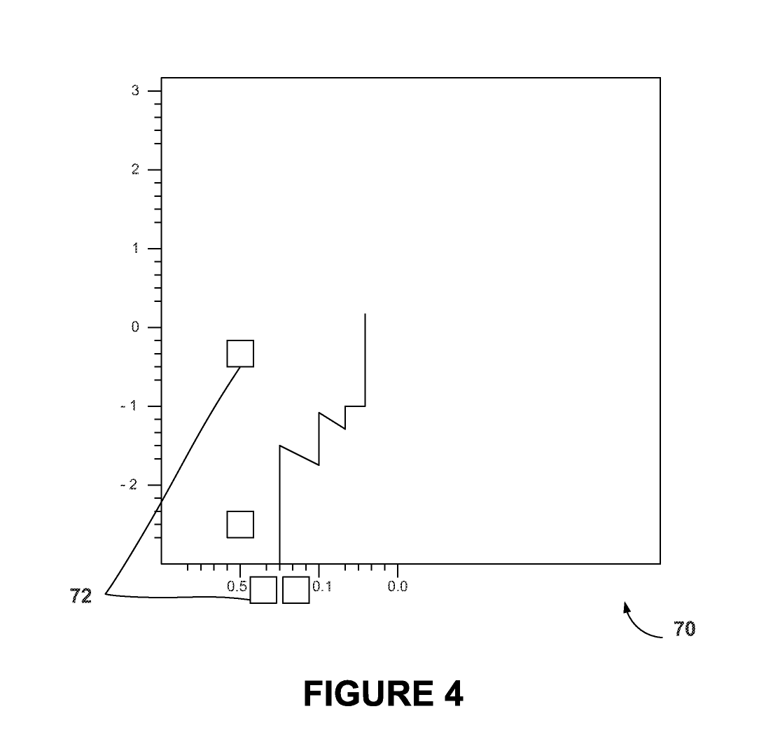

FIG. 4 is a graphical representation illustrating dynamic mapping and localization 70 of a robotic unit, according to one embodiment. In one or more implementations, a robotic unit such as any of those depicted in FIGS. 1-3 may dynamically localize and map its position when it moves around in the user environment. As mentioned above, the dynamic mapping of the unit movement may be achieved through SLAM. When the unit detects a land mark (e.g., land mark 72) while navigating, the unit may represent it on the graph as illustrated in FIG. 4.

When the robotic unit 14 is manually moved from its position by a user, the unit 14 can estimate its position in the environment using the filters (e.g., Kalman filter, etc.) and once again begin moving in the direction of path marks. Once the unit 14 identifies a landmark, the unit 14 can update its position on the map as illustrated in FIG. 4.

Alternatively, the robotic unit 14 can move around the user's environment by any known method of robotic movement. In a further alternative, the personal assistance unit 14 can be a stationary unit 14 that can perform many of the same functions described herein from its stationary position in the user location, whether that is the user's home, a nursing home, a hospital, or any other location. In further alternative implementations, the unit 14 can be a stationary unit 14 that is integrated into a house or building, such as a unit similar to an audiovisual system with components distributed in two or more locations or rooms in such a building. In such an implementation, the unit 14 might have one or more interfaces, one or more speakers, one or more recording devices, and/or one or more of any other unit components described or contemplated herein, all of which can be distributed to one or more different locations in a house or building.

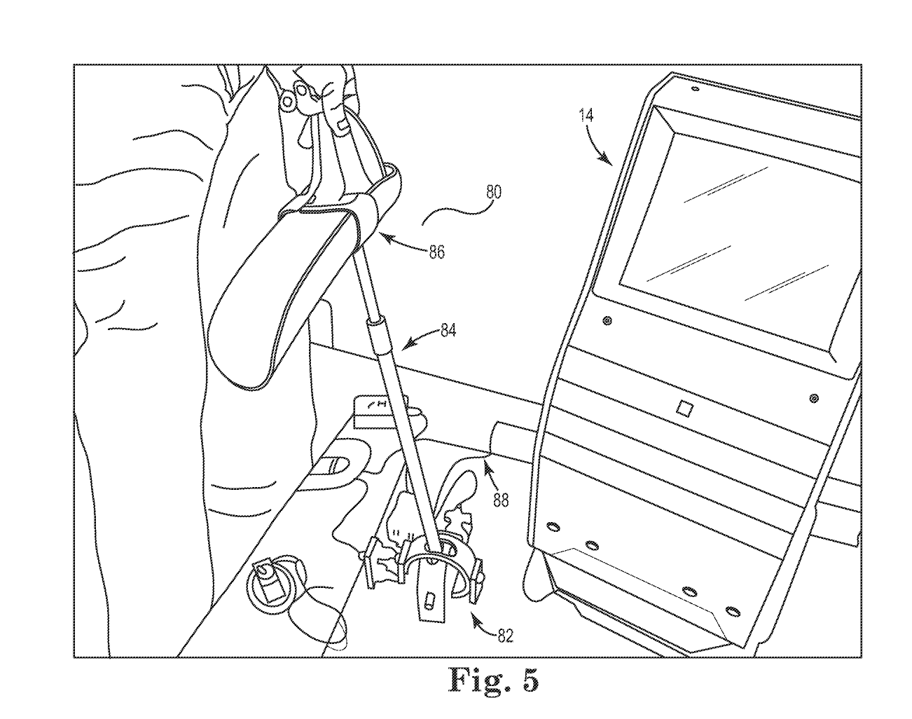

FIG. 5 depicts an exercise device 80 that can be coupled to a system and/or a unit according to various embodiments. In this embodiment, the device 80 is an arm exercise device 80 coupled to the unit 14 for providing exercise routines for patients. As shown, the device 80 has a base 82, an elongated body 84 pivotally coupled to the base 82, and a hand receiving component 86 pivotally coupled to the elongated body 84. According to one alternative embodiment, the device 80 also has adjustable resistance components (not shown) that can be used to provide desired amounts of resistance to the user during the exercise routine. Alternatively, the device 80 can also have motors (not shown) operably coupled to the components such that the motors operate to move the device 80 through a range of motions while the user is grasping the hand receiving component 86. In a further embodiment, the device 80 also has sensors (not shown) disposed on its various components to detect the various movements of the user, the amount of movement (such as, for example, the range of motion), the amount of force used by the user to perform the exercise, the amount of effort expended by the user, and any other measurable parameters relating to the use of the device 80. The device 80, according to one implementation, is configured to be used by a user sitting in a chair next to the device 80 and grasping the hand receiving component 86 with one hand. In one implementation, the device 80 is used to treat stroke patients and specifically to assist in improving their arm function, including, in some examples, actively moving the patient's arm and working against the cramped muscles or stiffness therein. It is understood that a unit 14 could be coupled to any number of similar exercise devices for exercising the legs, hands, or other body parts of a stroke patient.

In one embodiment as shown, the exercise device 80 is operably coupled to the unit 14 with a cord 88 or other form of physical connection that allows for power to be transmitted from the unit 14 to the device 80 and for electronic signals and any other forms of communication to be transmitted back and forth between the unit 14 and device 80. Alternatively, the unit 14 and device 80 can be coupled wirelessly. In various embodiments that will be described in further detail below, the unit 14 has software that provides for allowing the user to perform exercises using the device 80, controlling the resistance provided by the device 80 during the exercise, and receiving the information collected by the sensors during the exercise.

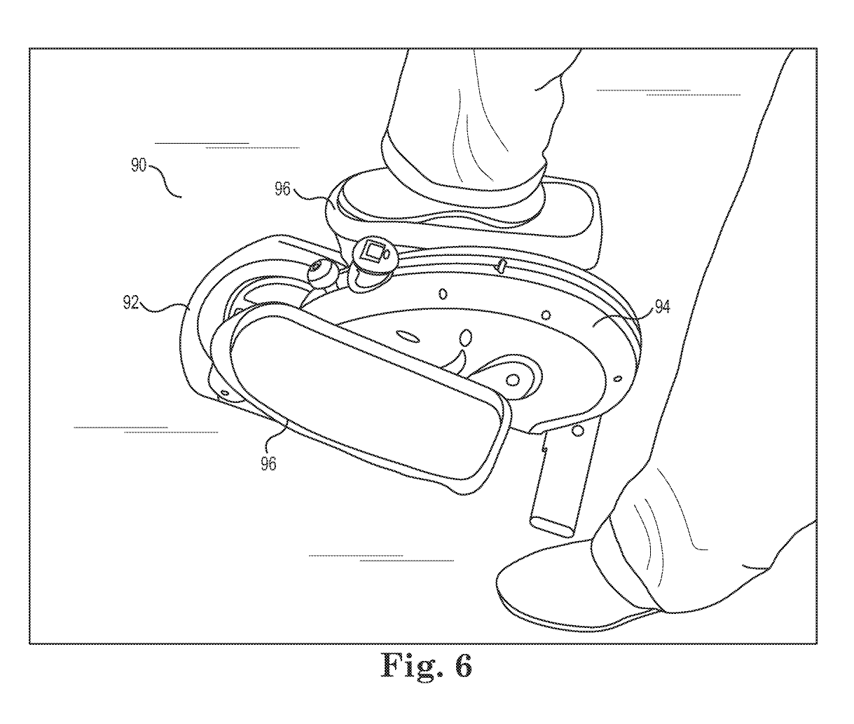

FIG. 6 depicts another exercise device 90 that can be coupled to a system and/or a unit according to various embodiments. In this embodiment, the device 90 is an exercise device 90 for providing exercise routines that provide leg exercise. Alternative similar devices include stationary bikes, treadmills, elliptical machines, or any other known devices or machines for providing leg exercise. As shown, the device 90 is a commercially available device having a base 92, a body 94 containing the known internal rotational components (not shown), and two pedals 96 rotationally coupled to the body 94. According to one alternative embodiment, the device 90 also has adjustable resistance components (not shown) that can be used to provide desired amounts of resistance to the user during the exercise routine. In a further embodiment, the device 90 also has sensors (not shown) disposed on its various components to detect the various movements of the user, the pedaling speed, the amount of force used by the user to perform the exercise, the amount of effort expended by the user, and any other measurable parameters relating to the use of the device 90. The device 90, according to one implementation, is used to treat patients who require improved leg or leg muscle function. In one embodiment, the exercise device 90 is operably coupled to the unit 14 with a cord (not shown) or other form of physical connection that allows for power to be transmitted from the unit 14 to the device 90 and for electronic signals and any other forms of communication to be transmitted back and forth between the unit 14 and device 90. Alternatively, the unit 14 and device 90 can be coupled wirelessly. In various embodiments that will be described in further detail below, the unit 14 has software that provides for allowing the user to perform exercises using the device 90, controlling the resistance provided by the device 90 during the exercise, and receiving the information collected by the sensors during the exercise.

It is understood that the devices 80, 90 described above are intended to be non-limiting examples of the types of exercise or interaction devices that can be coupled to units and/or a system (such as, for example, the units 14A-14E and/or the system 10 described herein) and controlled by the units and/or system for purposes of providing interactive support or assistance to a user. Any known device that can be used in such a manner is contemplated herein.

In use, the various personal assistance systems and units contemplated herein can interact with a user or users in the user environment and provide assistance or support to the user or users in any number of ways. For example, in one embodiment, a unit, such as, for example, any of the units 14 depicted in FIG. 1, can encourage or stimulate a user to adhere to a particular protocol or action (such as, for example, exercise or taking medication, etc.) via instructions using text, audio and/or visual cues. In another exemplary implementation, the unit 14 is configured to provide a reminder to the user about one or more upcoming events, appointments, or deadlines, and, in some versions, further provide instructions for appropriate actions relating to the upcoming events, appointments, or deadlines. For example, the unit 14 can remind the user to consume appropriate medication at the appropriate time, or can remind the user to take particular steps relating to a workout or diet regimen. In yet another exemplary embodiment, the unit 14 can provide entertainment to the user in the form of music, television, games, video, books, etc. Further specific embodiments of each of these types of assistance will be described in further detail below.

In any of these embodiments, the unit and associated system (such as, for example, the unit/units 14 and the system 10 described herein) are configured to “learn” over time. That is, the unit 14 and system 10 can collect user information over time and use any trends or patterns relating to the user to either take some action such as providing new instructions or other new information to the user to encourage the user to modify her or his behaviors or automatically adapt over time to the user's preferences or interactions with the unit 14. For example, the unit 14 can collect information about the user's actions and transmit that information to a central processor to which the unit 14 is coupled (such as, for example, the server 12 depicted in FIG. 1). The server 12 can be configured to store the information and subsequently process information collected over time to detect any patterns or predetermined triggers in the actions of the user over time and, based on that pattern or trigger, take some predetermined action such as transmitting new instructions to the user or any other type of action that can be used to modify the user's behavior or provide the user with new information.

It is understood that in any of the assistance embodiments contemplated herein, the assistance or support provided by the unit 14 for the user over time can result in a pseudo-relationship developing between the user and the unit 14 in which the user comes to enjoy the interaction and perhaps depend on the unit 14, thereby potentially further motivating the user to comply with the instructions provided by the unit 14.

In the various personal assistance embodiments contemplated herein in which the unit 14 is a mobile robotic unit 14, the unit 14 can interact with the user by moving around the user environment. For example, in various implementations, the unit 14 can be configured to move around the user environment in search of the user (e.g., patient) or users in order to provide some instructions or other information to the user. In other words, the unit 14 will be programmed to perform a search of the environment to find the user and, upon locating the user, will provide the instructions or information (such as textual, audio, or other forms of instructions relating to an impending deadline or required action). In one embodiment, the unit 14 is configured to search for the user using a camera on the unit 14 in combination with some facial recognition software or some other type of known recognition software. Alternatively, the unit 14 can have a detector and the user can wear or otherwise have attached the user's person a beacon or other type of personal marker that can be sensed or detected by the detector, thereby locating the user. In a further embodiment, any known functionality for locating the user can be used. Once the unit 14 has located the user, the unit 14 can be configured to perform its operation to provide the appropriate information to the user. For example, the unit 14 can be configured to approach the user and provide the instructions to the user in audio form. Alternatively, the unit 14 can be configured to perform any appropriate action upon locating the user. In another embodiment, after the unit 14 has located the user, if the user moves away from the unit 14 or leaves the vicinity of the unit 14, the unit 14 can be configured to follow or attempt to locate the user again. Alternatively, the unit 14 can be configured to transmit an audio message encouraging the user to return to the vicinity of the unit 14 and/or interact with the unit 14.

Various embodiments relating to interactions between a system and a user will now be described.

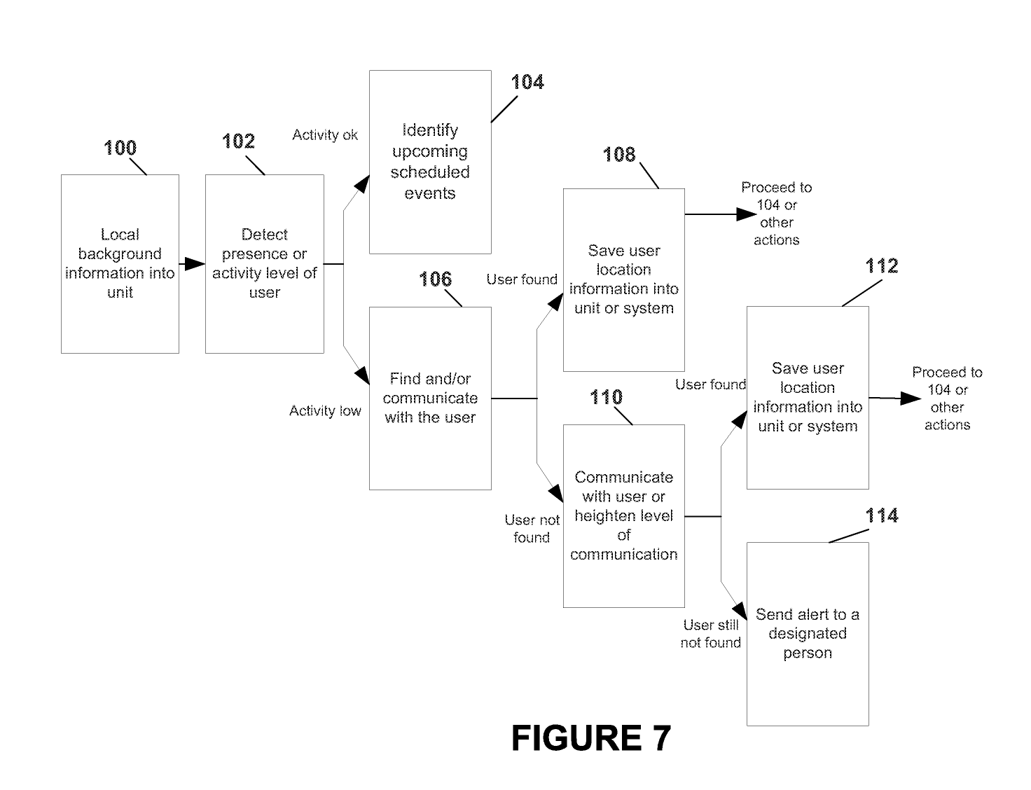

In one embodiment, as shown in FIG. 7, the system and/or unit (such as, for example, the system 10 and/or unit 14 as described herein) is configured to establish communication with the user or users. This communication establishment may occur daily, multiple times each day, on any predetermined schedule, or only as actuated by a controller or a user. In this embodiment, prior to an initial interaction, the unit 14 receives some background or user-specific information about the user (block 100). More specifically, the system 10 can load background or user-specific information into the unit 14 (block 100). The user-specific information can include basic information about the user such as the user's name, age, etc. In addition, the user-specific information can include certain historical or legacy data relating to the user's prior activities or prior actions that are relevant to providing assistance to the user. For example, in certain embodiments in which the system 10 is providing treatment adherence support relating to scheduled medication consumption, the background information can include the required medication consumption schedule. In another example according to certain implementations, the user-specific information can include the user's historical medical records. Alternatively, this background or legacy information can be loaded not only prior to an initial interaction, but also on a regular basis, such as daily, weekly, or based on any other time period.

According to one implementation, the unit 14 is configured to initiate establishment of communications with the user by detecting or sensing the user's (or users') presence and/or activity level(s) (block 102). That is, the unit 14 can actuate a sensor (or more than one sensor) configured to sense the presence and/or activity level of the user or users. The unit 14 can also use GPS technology in combination with the sensor to identify the user's location. In one example, the sensor is a camera or cameras that are configured to detect the presence of the user. Alternatively, the sensor(s) can be any other known sensor of any kind that can be used to detect the presence or activity level of the user. In certain implementations, the sensor can be a sensor to detect foot pressure of the user in a specific location, a heart rate sensor, a blood pressure sensor, or any other type of sensor to detect a user's physical characteristics.

If the user is present and/or the user's activity is normal, then the unit 14 can then be triggered to begin its specific, predetermined interaction with and support of the user. For example, in the embodiment depicted in FIG. 7, if the user is present and/or the user's activity level is normal, then the unit 14 is programmed to check the user's calendar for any appointments or deadlines or scheduled actions (such as, for example, taking medication) (block 104). It is understood that “checking the user's calendar” means reviewing the calendar information previously provided to the unit. In addition, it can include receiving new information from the system relating to a new deadline, activity, or other newly scheduled event of any kind. If there are impending deadlines or scheduled actions, the unit is programmed to act accordingly. For example, the user's scheduled events or activities may include medication consumption, specific exercise activities, appointments, etc.

Alternatively, if the user's presence is not detected and/or the user's activity is low, then the unit 14 can be triggered to attempt to find and/or communicate with the user (block 106). In one embodiment, the unit 14 is a robotic unit 14 that physically performs a search by moving around the user environment. In one embodiment, when the unit 14 arrives in a room or other location where it detects the presence of the user, the unit 14 can be prompted to transmit an audio message or other kind of audio alert to request a response from the user. The unit 14 can be configured to detect an audio response from the user or can alternatively be configured to detect a physical response (such as, for example, the user pressing a button on the unit when prompted). Alternatively, in embodiments in which the unit 14 is not a mobile robot or movement is unnecessary or undesirable, the unit 14 can be prompted to transmit an audio message or other kind of audio alert or alarm without moving to request a response from the user.

If the user is found and/or responds to the unit's prompt, then the unit 14 can save the information about the location of the user into the unit 14 and/or the system 10 (block 108). The unit 14 can then proceed to perform any number of interactive functions as described elsewhere herein, such as, for example, identifying upcoming scheduled events or any other relevant function relating to supporting or assisting the user.

Alternatively, if the user is not found, the unit 14 can be figured to either attempt to communicate with the user or to heighten the level of its previous communication attempt (block 110). For example, the unit 14 can be configured to contact the user through a text message, voice message, and/or even by calling the user's phone (e.g., wired phone, wireless phone) and transmitting a predetermined message to request a response. In those embodiments in which the unit 14 has previously attempted to communicate with the user, the unit 14 can heighten the level of the communication attempt by sounding some kind of alarm or transmit an audio message or communication at a higher volume than the previous communication. Alternatively, the heightened communication can include both an alarm and a phone call or any other heightened attempt to communicate with the user.

If the user is found and/or responds to the unit's communication attempt, then the unit 14 can save the information about the location of the user into the unit 14 and/or the system 10 (block 112). The unit 14 can then proceed to perform any number of interactive functions as described elsewhere herein, such as, for example, identifying upcoming scheduled events or any other relevant function relating to supporting or assisting the user. Alternatively, if the user still cannot be found or does not respond, the unit 14 or system 10 can be configured to transmit an alert to a predetermined, designated person (block 114), notifying them that the user is not responding to the unit 14. The designated person can be a clinician, guardian, a relative, or any other appropriate person who can follow up to determine if the user needs human assistance. The designated person can be alerted by sending a text message or any kind of electronic message (e.g., SMS, email, Tweet, etc.) and/or by calling the person over the phone if the phone number was previously provided to the unit 14 or system 10.

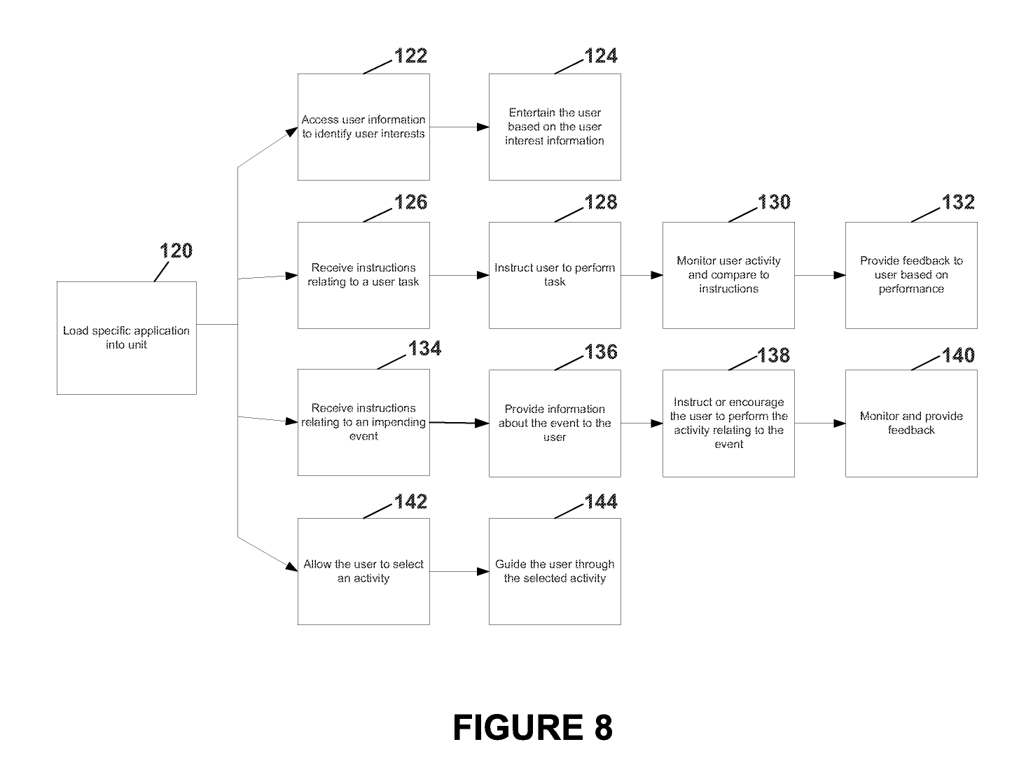

FIG. 8 is a flowchart in accordance with one embodiment depicting various types of interaction between a unit or system (such as a unit 14 or system 10 as discussed above) and a user or users after the initial communication is established. For example, in one implementation, once communication is established between the unit 14 and the user, the system 10 can load a specific or predetermined user application into the unit 14 (block 120). According to one embodiment, the user application is specific to the user. In variations in which the unit 14 is located in an environment with multiple users, the unit 14 must first establish communication with and identify the user in order to trigger the loading of the appropriate user application into the unit 14. In other variations, the application or software being loaded into the unit 14 can include updated or new information provided by the system 10 or a controller (such as, for example, human controller 20 discussed above) inputting new information into the system 10 since the previous application/software load. For example, the user-specific information discussed above may have been updated by a clinician (e.g., consultant, surgeon, etc.) or other professional who may be treating or otherwise assisting the user. Alternatively, the loading step can be unnecessary because the appropriate application or software is already present in the unit 14. In addition, in one embodiment, the unit 14 can be configured to continuously or periodically communicate with the system 10 to confirm the presence of any new messages or other information to be received and processed by the unit 14.

Once any information has been loaded into the unit 14 (or the unit 14 has confirmed that no new information is available or if the unit 14 is scheduled to confirm the availability of new information at a later time), the unit 14 can be configured to perform any one or more of a number of preprogrammed interactions with the user or users. For example, in one embodiment, the unit 14 can be configured to access the user information to identify interests of the user (block 122) and provide entertainment to the user based on that user interest information (block 124). According to one implementation, the unit 14 can be configured to monitor the activity of the user and be triggered based on a low activity level to provide entertainment. Alternatively, for a different user with different interests that are saved in the user information, the unit 14 could be triggered based on a high activity level to provide entertainment. As described elsewhere, the unit 14 and system 10 can be configured to interact with and be triggered to take certain actions in relation to a user based on the specific user's likes, dislikes, or personality as determined by the system 10 or unit 14 based on multiple interactions with the user, in combination with the goals or parameters set out for the specific user. In this specific example of providing entertainment, the entertainment can be broadcasting predetermined music, displaying a predetermined television show or movie or other similar media, displaying an interactive video game for the user to play, or any other type of known entertainment.

In another example as shown in FIG. 8, the unit 14 can be configured to receive instructions relating to a task that the user is supposed to perform (block 126). Upon receiving the information about the instructions, the unit 14 can be triggered to provide the instructions to the user (block 128). As discussed above, these instructions can be provided to the user in any known form, such as by audio message, text message, or in any other known form. For example, if the user is supposed to perform a specific exercise, the unit 14 can provide specific instructions about how to perform the exercise. The unit 14 can also be configured to monitor the user activity and compare it to the required activity (block 130) and then be triggered to provide feedback to the user based on that comparison (block 132). If the user is performing the instructed activity successfully, the unit 14 can be triggered to provide praise to the user (in audio form, textually, or in any other form), and if the user is not performing successfully, the unit can be triggered to provide encouragement to the user (also in any form). Alternatively, the triggered feedback can be customized or specifically designed to a specific user and that user's preferences and/or personality. For example, in one embodiment with a specific user that reacts more positively to constructive criticism or more aggressive commands, the unit 14 (or software therein) can be configured to provide that in the desired context. Thus, the system 10 can be configured to perform triggered actions that are specific to the user, either because the actions are predetermined actions that were entered into the system 10 (perhaps by a human controller) or because the actions were automatically created by the system 10 as a result of the system gathering information about the user over time (“learning” about the user). More specific examples of user tasks will be described below.

According to one specific example relating to the unit 14 instructing a user regarding a task and monitoring the performance of the task, the unit 14 or system 10 can be coupled to an exercise device such as one of the exercise devices 80, 90 depicted in FIG. 5 or 6 and described above. In such an exemplary embodiment in which, for example, the device 80 of FIG. 5 is used, the unit 14 can be triggered to provide instructions to the user relating to the specific exercises to be performed on the device 80 (block 128). As discussed above, these instructions can be provided to the user in any known form, such as by audio message, text message, or in any other known form. For example, if the user is supposed to perform a specific exercise, the unit 14 can provide specific instructions about how to perform the exercise. The unit 14 can also be configured to monitor the user activity and compare it to the required activity (block 130). In one embodiment, the unit 14 can collect information from the sensors relating to the user's performance of the exercise routine (such as number of sets, number of repetitions, amount of force, amount of speed, amount of effort, and any other measurable parameters) and compare the collected information to the required or expected levels for each of those parameters. The unit 14 can then be triggered to provide feedback to the user based on that comparison (block 132). If the user is performing the instructed activity successfully with respect to all parameters, the unit 14 can be triggered to provide praise to the user (in audio form, textually, or in any other form), and if the user is not performing successfully with respect to any specific parameter, the unit 14 can be triggered to provide encouragement to the user (also in any form). Alternatively, if the user is performing the exercise incorrectly, the unit 14 can be triggered to provide instructions to the user that can assist the user with correcting her or his performance.

In a further implementation depicted in FIG. 8, the unit 14 can be configured to receive instructions relating to a previously scheduled event or events (block 134). Upon receiving the information about the event(s), the unit 14 can be triggered to provide information to the user about the event(s) and the timing thereof (block 136). In one embodiment, the information can be provided to the user in the form of a calendar listing all upcoming events for the day, for the week, or for any other reasonable time period. Alternatively, the information can be provided in any form. In some alternative embodiments, the unit 14 can also be configured to instruct or encourage the user to perform the activity or task relating to the event (block 138). In further alternatives, the unit 14 can also be configured to monitor the user's performance and provide feedback (block 140) in a fashion similar to that described above.

In yet another example as shown in FIG. 8, the unit 14 can be configured to allow the user to manually select an activity (block 142). In one embodiment, the unit 14 has an interface that allows the user to select an activity. The selected activity can be any of the activities contemplated herein, including entertainment, exercise, or any other such activity. Once the user makes a selection, the unit 14 can be configured to guide the user through the selected activity as described according to the various embodiments herein (block 144).

As described above, the various embodiments contemplated herein include systems having units that allow users at different locations to communicate with each other via their personal interaction units. As such, according to one implementation, any of the interactions described above with respect to FIG. 8 (and any other interactions described herein) can also include a user communicating with one or more additional users before, during, or after the interaction. In one non-limiting example, a user at a first interaction unit that is performing an exercise routine can communicate with another user at a second interaction unit about that exercise routine. In a further non-limiting example, both users can perform the same exercise routine and communicate with each other during the routine using their respective units. Similarly, in certain embodiments, multiple users can interact with their units while communicating with each other. This user communication can provide each such user with additional social and emotional support during the user's interaction with unit, thereby further enhancing the benefits of the support provided by the unit.

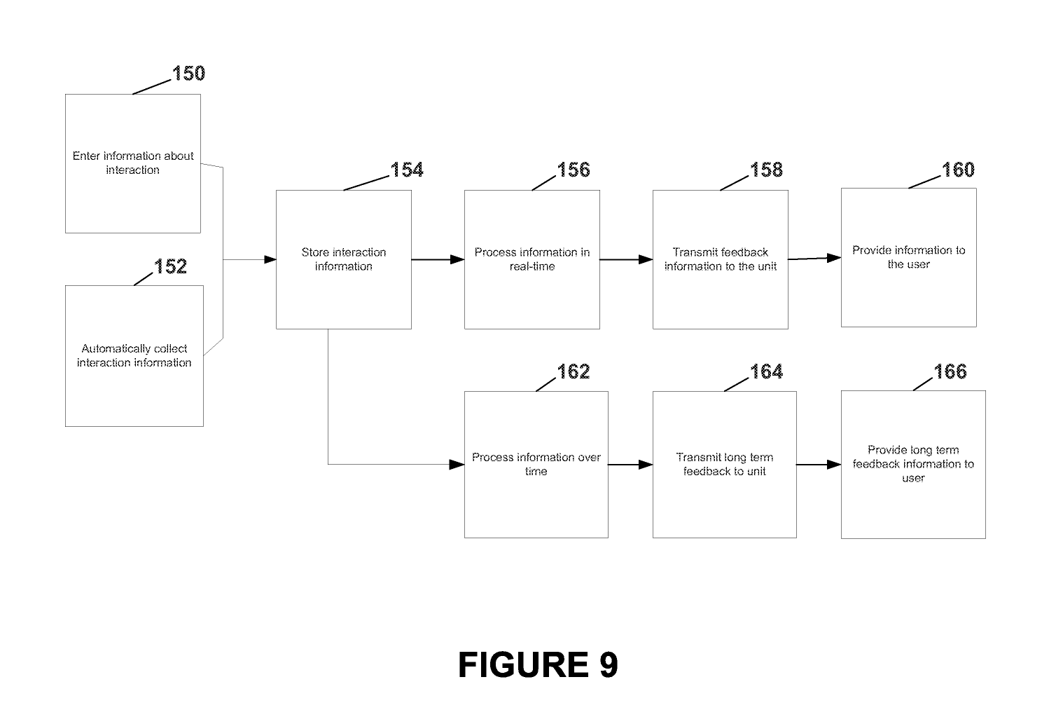

As shown in FIG. 9, the various system and unit embodiments contemplated herein (such as, for example, the system 10 and unit 14 described above) can also, according to one implementation, provide for tracking, storing, and processing information relating to the user's interaction with the unit 14 for purposes of providing a program of support or assistance to the user or users over time. In one variation, the unit 14 and/or system 10 allows the user to manually enter or “log” information about the interaction with the unit 14 (block 150). For example, if the user performed an exercise, the user can enter information into the unit interface 18 relating to the exercise, including the type of exercise, the number of sets, the number of repetitions, the amount of time performing the exercise, the amount of weight or resistance or the setting used for the exercise, and/or any other parameters relating to the exercise. In another example, if the user took medication as previously scheduled, the user can enter information relating to that. Alternatively, the unit 14 can be configured to automatically enter or otherwise collect the interaction information (block 152). For example, in one embodiment in which the system 10 includes an exercise device coupled to the unit 14 and/or system 10 (such as, for example, one of the devices 80, 90 described above), the device or the unit 14 can have sensors that detect the number of sets, the number of repetitions, the amount of effort, the amount of time, or any other detectable parameters associated with the user's exercise using the device.

Once the information has been entered, whether manually or automatically, the information or data can be stored in the unit 14 and/or in the central processor 12 of the system 10 (block 154). Once the data is stored, the unit 14 and/or the system 10 are configured to have software that allows for specific processing of the data in real-time (block 156). In one embodiment, the software can provide for immediate or real-time processing and analysis of the information that triggers feedback information transmitted to the unit 14 (block 158) and provided to the user in audio or visual form or any other form (block 160). For example, if the user was performing a specific exercise, the software can process the data relating to the performance (block 156) and, if the performance met or exceeded expectations, the software can trigger the processor to transmit a message to the unit 14 (block 158) (and thereby to the user (block 160)) that the performance was successful and perhaps include details about the performance. In this same example, if the performance did not meet predetermined expectations (which might be measured by any performance parameter such as number of sets, number of repetitions, amount of effort, amount of time, or any other such parameter), then the software can trigger the processor to transmit a message about the performance, including, in some embodiments, details about the parameter(s) that fell below the predetermined level(s). In further alternative, embodiments, the software can also analyze the information for the purpose of transmitting suggestions to the user regarding actions to improve performance or otherwise alter the user's behavior based on the user's interaction.

In an alternative implementation, the software can provide for processing and analysis of the interaction information over time (block 162) that can trigger long-term feedback information transmitted to the unit (block 164) and provided to the user in audio or visual form or any other form (block 166). For example, if the user has been performing a specific exercise over time, the software can process the data relating to the most recent performance by comparing that data to past performances to detect any trends in the data over time (block 162). As part of this processing step, the software can utilize any trend information to develop a new exercise routine or develop any new actions for the user based on the trend information. That is, if the user has not shown improvement in the performance of the exercise and/or in the user's physical condition as a result of the exercise, then the software can be configured to recognize that trend in the data and develop a new exercise routine or even a new recommended diet or other types of actions for the user that can help to improve the user's performance. Similarly, if the user has shown improvement and/or met the user's predetermined goal(s), the software can be configured to develop a revised routine on the basis of that trend. It is understood that the software can be configured to provide similar long-term analysis and feedback for any number of user actions or user needs beyond exercise.

In one specific exemplary embodiment relating to processing and providing long term feedback, the unit 14 and/or system 10 can have software configured to process and analyze the preferences of the user over time (block 162). That is, the software can analyze information relating to the manual selections made by the user (such as, for example, a user's selections relating to entertainment as described above). Alternatively, the software can also analyze information relating to choices or selections made or actions taken by a user during the course of any type of interaction with the unit, such as preferred time for exercise during the day, preferred times for meals during the day, preferred day of the week to make a required appointment with a physician or trainer or any other profession, etc.) Based on this trend analysis relating to the user's preferences, the software can be configured to trigger the processor to transmit instructions to the unit 14 (block 164) to take specific actions based on the detected trends or preferences of the user. For example, in one embodiment, the software can be configured to trigger the unit 14 to play a preferred song or genre of songs to wake the user, get the user's attention, or for any other relevant use without requiring a specific request for that song from the user. In another example, the software can be configured to transmit a reminder to the unit 14 to be provided to the user at a time that seems to be preferred by the user based on the user's actions over time. In a further alternative, the software can be configured to utilize any preference information to trigger the processor to provide specific instructions to the unit 14 relating to any action that is geared toward the preference(s) of the user.

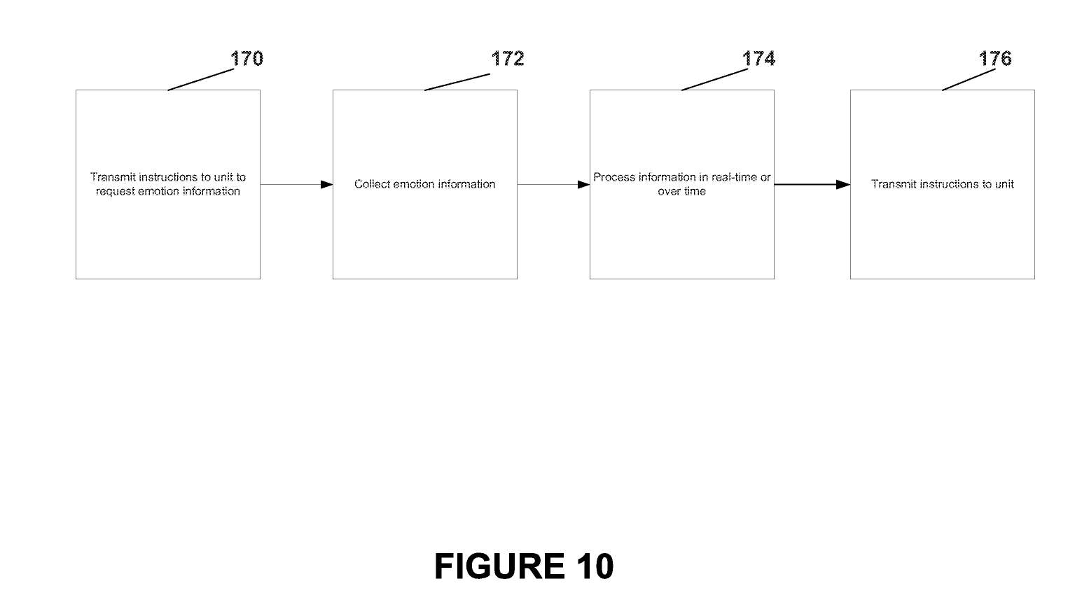

In another embodiment as shown in FIG. 10, the unit and/or system (such as, for example, the unit 14 and/or system 10 discussed above) can have software configured to process and analyze the emotions of the user in real-time or over time. That is, the software can trigger the processor 12 to transmit instructions to the unit 14 to request information from the user regarding how the user is feeling (block 170). Alternatively, the software can trigger the processor 12 to transmit instructions to the unit 14 to request information from another source, such as video, a sensor, a database, or any other source. In one variation, the unit 14 requests such information after the user completes a task. Alternatively, the unit 14 requests such information after the user fails to complete a task, such as a scheduled task. In a further alternative, the unit 14 requests such information at any time. The system is configured to collect this information (block 172). The software is further configured to process and analyze the emotion information in real-time or over time (block 174). That is, the software can process the information in real-time by comparing the emotion information to a baseline. Alternatively, the software can process the information over time by comparing recent emotion information with past emotion information to detect any trends. As part of this analysis, the software can utilize the baseline information (in the case of real-time processing) or trend information (in the case of long term processing) to develop or create new tasks or new entertainment or other new interactions between the unit 14 and the user based on the detected trend in the user's emotion. For example, if the user indicates a negative emotion with respect to a specific exercise over time, the software can be configured to adjust the exercise routine. In a further example, if the user indicates a position emotion with respect to a specific form of entertainment over time, the software can be configured to provide that entertainment more often. Based on this analysis, the software can trigger instructions to be sent to the unit 14 relating to the new or adjusted exercise routine, the specific form of entertainment to be provided, or any other new instructions (block 176).

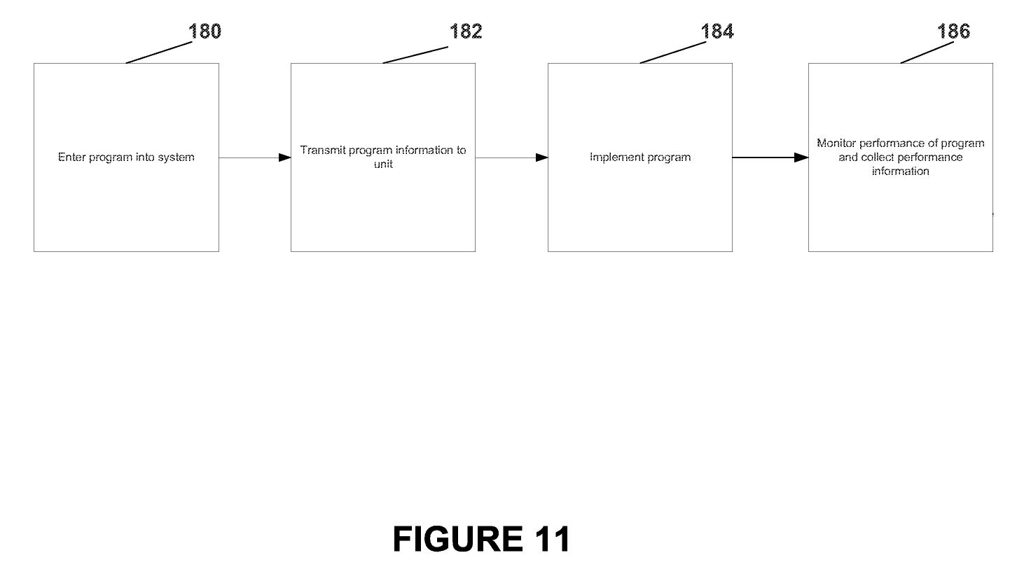

FIG. 11 depicts another embodiment in which a system according to any of the implementations described herein (such as, for example, the system 10 described above) can allow a human controller to create, develop, or otherwise provide a user interaction, such as, for example, an exercise routine, for a user to follow, according to one embodiment. First, the controller enters the program into the system 10 (block 180). In one embodiment, the controller provides the program by creating the program herself or himself at the interface 18. Alternatively, the controller provides the program using a template available in the system 10. In a further embodiment, the controller uploads information relating to an existing program to the system 10 via the interface 18 or some other connection to the system 10. The system 10 then transmits the information relating to the program or routine to the unit 14 (block 182), which implements the program or routine according to various possible steps as described elsewhere herein (block 184). In one alternative implementation, the system 10 and unit 14 also provide for the human controller (such as, for example, a therapist) to log on or otherwise connect to the system 10 and assist the user in real-time via the unit. In accordance with a further implementation, the system 10 can also provide for tracking or monitoring the performance of the program and collecting the performance information (block 186) for further processing according to various embodiments described elsewhere herein.

Although the present embodiments have been described with reference to specific example embodiments, it will be evident that various modifications and/or changes may be made to these embodiments without departing from the broader spirit and/or scope of the various embodiments. For example, a combination of hardware circuitry (e.g., CMOS based logic circuitry), firmware, and/or software (e.g., embodied in a machine readable medium) may be used to enable the viral growth extension through recommendation optimization in online communities disclosed herein to further optimize function. Additionally, the various electrical structure and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a machine-readable medium or a machine accessible medium compatible with a data processing system (e.g., a computer system), and may be performed in any order (e.g., including using means for achieving the various operations). It is also within the scope of an embodiment to implement a program or code that can be stored in a machine-readable medium to permit a computer to perform any of the methods described above.

The structures and/or modules in the figures are shown as distinct and communicating with only a few specific structures and not others. The structures may be merged with each other, may perform overlapping functions, and may communicate with other structures not shown to be connected in the Figures. Accordingly, the specification and drawings are to be regarded in an illustrative rather than a restrictive sense.

Although the present invention has been described with reference to preferred embodiments, persons skilled in the art will recognize that changes may be made in form and detail without departing from the spirit and scope of the invention.

What is claimed is:

1. A network-based personal support system for at least one user, the system comprising:
(a) a central processor accessible on a computer network;
(b) a database in communication with the central processor, the database configured to store user information;
(c) a controller interface in communication with the central processor;
(d) at least one personal interaction unit in communication with the central processor and disposed at a user location, the personal interaction unit comprising:
(i) a unit processor associated with the personal interaction unit;
(ii) a user interface associated with the personal interaction unit; and
(iii) at least one speaker associated with the personal interaction unit;
(e) location software associated with the system, the location software configured to transmit instructions to the unit to perform an initial search for a specified user;
(f) entertainment software associated with the system, the entertainment software configured to transmit instructions to the unit to actuate an entertainment module, wherein the entertainment module comprises music, a video broadcast, or an interactive game; and
(g) reminder software associated with the system, the reminder software configured to transmit at least one reminder to the user via the user interface regarding an impending deadline or event.

2. The system of claim 1 wherein the personal interaction unit is a robotic unit comprising a motor, a set of wheels operably coupled to the motor, and at least one sensor associated with the unit, the at least one sensor configured to sense landmarks or path marks for navigation.

3. The system of claim 1, wherein the personal interaction unit is a stationary unit disposed at a central location in a building at the user location.

4. The system of claim 1, further comprising a plurality of personal interaction units in communication with the central processor and disposed at a plurality of user locations.

5. The system of claim 1, wherein the at least one personal interaction unit further comprises a camera and a microphone.

6. The system of claim 1, wherein the user location comprises a plurality of users, wherein the at least one personal interaction unit is configured to interact with each of the plurality of users.

7. The system of claim 1, further comprising exercise software associated with the system, the exercise software configured to transmit instructions to the user via the user interface regarding an exercise routine.

8. The system of claim 7, further comprising at least one exercise device operably coupled to the personal interaction unit, wherein the exercise software is further configured to transmit instructions to the user regarding the exercise routine using the at least one exercise device.

9. The system of claim 7, wherein the exercise software is further configured to collect data relating to the exercise routine and analyze the data.

10. The system of claim 1, wherein if the initial search is unsuccessful, the location software is further configured to transmit additional instructions to the unit to either perform a more intensive search or to transmit at least one sound to get the specified user's attention.

11. The system of claim 10, wherein, if the more intensive search or the at least one sound is unsuccessful, the location software is further configured to transmit a communication to a designated person or location.

12. A network-based personal support system for at least one user, the system comprising:
(a) a central processor accessible on a computer network;
(b) a database in communication with the central processor, the database configured to store user information;
(c) a controller interface in communication with the central processor;
(d) at least one personal interaction unit in communication with the central processor and disposed at a user location, the personal interaction unit comprising:
(i) a user interface associated with the personal interaction unit; and
(ii) at least one speaker associated with the personal interaction unit;
(e) exercise software associated with the system, the exercise software configured to transmit instructions to the user via the user interface regarding an exercise routine;
(f) reminder software associated with the system, the reminder software configured to transmit at least one reminder to the user via the user interface regarding an impending deadline or event; and
(g) feedback software associated with the system, the feedback software configured to process user interaction information and transmit feedback information to the user via the personal interaction unit.

13. The system of claim 12, wherein the personal interaction unit is a stationary unit integrally incorporated into at least one room of a building at the user location.

14. The system of claim 12, further comprising a plurality of personal interaction units in communication with the central processor and disposed at a plurality of user locations.

15. The system of claim 12, wherein the user location comprises at least one user, wherein the at least one personal interaction unit is configured to interact with the at least one user.

16. The system of claim 12, further comprising at least one exercise device operably coupled to the personal interaction unit, wherein the exercise software is further configured to transmit instructions to the user regarding the exercise routine using the at least one exercise device.

17. The system of claim 12, wherein the exercise software is further configured to collect data relating to the exercise routine and analyze the data.

18. A network-based personal support system for a plurality of users, the system comprising:
(a) a central processor accessible on a computer network;
(b) a database in communication with the central processor, the database configured to store user information relating to a plurality of users;
(c) a controller interface in communication with the central processor;
(d) a plurality of personal interaction units, each of the plurality of units being in communication with the central processor and disposed at a multi-user location, the personal interaction unit comprising:
(i) a user interface associated with the personal interaction unit; and
(ii) at least one speaker associated with the personal interaction unit;
(e) exercise software associated with the system, the exercise software configured to transmit instructions to the user via the user interface regarding an exercise routine;
(f) reminder software associated with the system, the reminder software configured to transmit at least one reminder to the user via the user interface regarding an impending deadline or event; and
(g) feedback software associated with the system, the feedback software configured to process user interaction information and transmit feedback information to the user via the personal interaction unit.

19. The system of claim 18, wherein the multi-user location is a hospital, clinic, treatment center, nursing home, or school.

20. The system of claim 18, wherein a first personal interaction unit of the plurality of personal interaction units is configured to communicate with a second of the plurality of personal interaction units via the computer network, whereby a first user of the plurality of users can communicate with a second of the plurality of users.
